(19) United States
(12) Patent Application Publication
(10) Pub. No.: US 2009/0157459 A1
(43) Pub. Date: Jun. 18, 2009

(54) COLLABORATIVE PROJECT MANAGEMENT

(75) Inventor: Denilson Nastacio, Apex, NC (US)

Correspondence Address: STRATEGIC PATENT GROUP, P.C., P.O. BOX 1329, MOUNTAIN VIEW, CA, 94042, US

(73) Assignee: INTERNATIONAL BUSINESS MACHINES CORPORATION, Armonk, NY (US)

(21) Appl. No.: 11/954,733

(22) Filed: Dec. 12, 2007

(51) Int. Cl. G06Q 10/00

(52) U.S. Cl. 705/8

(57) ABSTRACT

A method for integrating a collaboration application with a project management application includes linking the activity with a task in the project management application in response to creation of an activity in the collaboration application. The collaboration application also receives a specification of a relationship between the activity and the task, including any dependencies between the activity and the task. The project management application is then updated with the activity.

### BACKGROUND OF THE INVENTION

Project management software as well as collaboration applications are commonly used business tools. Project management software is a term that may be used to cover many types of software used to control the scheduling, budget management, resource allocation, and/or quality management of complex projects. One common feature of project management software is the scheduling of tasks. Some scheduling challenges may include defining how the tasks depend on one another, scheduling resources required by the various tasks; estimating the duration of each task; and arranging the tasks to meet various deadlines, for example.

Project management software can be implemented as a collaborative system designed for multiple end-users to modify different sections of a project or plan. Web-based tools, including extranets, currently fit into this category, but may have the limitation that they can only be used when the user has a live Internet access. To address this limitation, client-server-based software tools exist to provide a rich client that runs on the user's desktop computer and replicates project and task information to other project team members through a central server when the users connect periodically to the network. Examples of such commercially available project management applications include RATIONAL PORTFOLIO MANAGER by International Business Machines of Armonk, N.J., and OFFICE PROJECT 2007 and ENTERPRISE PROJECT MANAGEMENT (EPM) by Microsoft Corporation of Redmond, Wash.

Collaboration applications, which have also been referred to as social software, includes software designed to help people involved in a common task to achieve their goals. Collaborative applications can help facilitate and manage end-user and group activities including, e-mail, appointments, to-do list items, and notes, for example. Collaboration applications may also be implemented as collaborative systems as described above. Examples of commercially available collaboration applications include LOTUS NOTES by International Business Machines of Armonk, N.J., and EXCHANGE SERVER and OUTLOOK 2007 by Microsoft Corporation of Redmond, Wash.

In enterprise environments, it is not uncommon for end-users to have both project-management clients as well as collaboration application clients running on their desktops, which may create a difficult choice for the end-user in terms of managing project information created from their collaboration application (such as scheduling meetings and creation of to-do items) and project information input directly into their calendars. In simpler terms, end-users often may prefer to use a collaboration application, such as a calendaring application, to host their appointments and tasks even when portions of that function are offered in a project management application. For the bulk of team members on a project, project management skills and access to the project management repository may not be readily available, whereas access to the collaboration application is much more pervasive and frequent.

Recognizing that some users preferred to work with project tasks in Outlook rather than Enterprise Project Management (EPM), Microsoft has offered a Project Web Access Add-in for Outlook that allows the import of project tasks from EPM to Microsoft Outlook. This solution, however, is limited in that there is no collaboration in the definition of the activities or schedule or the dependencies thereof, and only tasks from EPM can be imported to Outlook clients.

### BRIEF SUMMARY OF THE INVENTION

A method for integrating a collaboration application with a project management application includes linking the activity with a task in the project management application in response to creation of an activity in the collaboration application. The collaboration client also receives a specification of a relationship between the activity and the task, including any dependencies between the activity and the task. The project management application is then updated with the activity.

### BRIEF DESCRIPTION OF THE DRAWINGS

FIG. 1 is a diagram illustrating an integrated collaboration application system in an enterprise networked environment according to one exemplary embodiment.

FIG. 2 is a flow diagram illustrating a process for integrating the collaboration application with the project management application in accordance with exemplary embodiment.

FIG. 3 is a flow diagram illustrating a process for integrating the collaboration application with the project management application in further detail.

### DETAILED DESCRIPTION OF THE INVENTION

The present invention relates to a system of method for integrating the collaboration application with the project management application. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The exemplary embodiment of the present invention provides a method and system for integrating project management functionality into a collaboration application at a user-interface level, so that an end-user can relate day-to-day activities, such as appointment, to-do list items, and notes, for example, with the contents of an enterprise project management application, thereby allowing users to leverage their collaboration application as a front-end to their project management application.

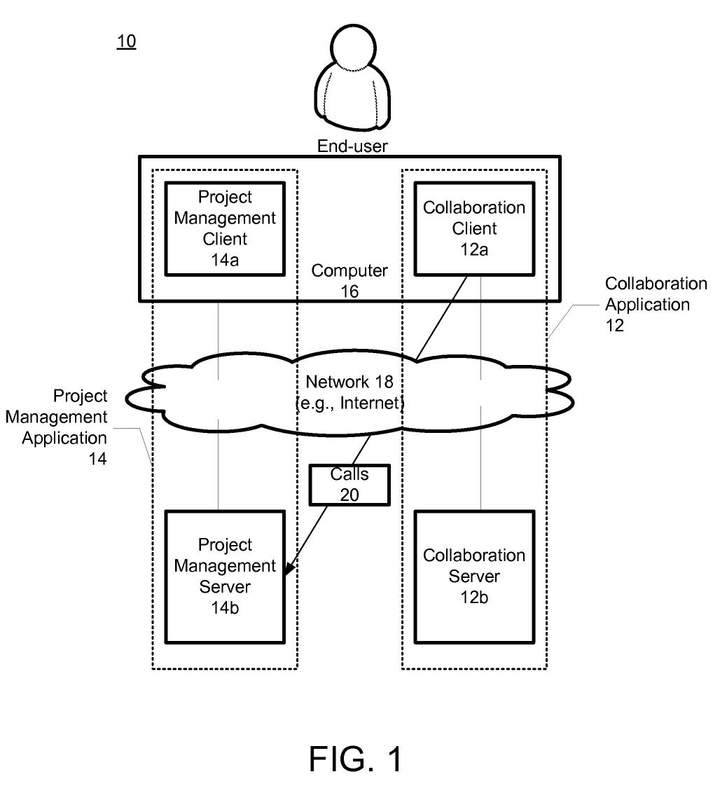

FIG. 1 is a diagram illustrating an integrated collaboration application system in an enterprise networked environment according to one exemplary embodiment. The system 10 includes a collaboration application 12, a project application 14, and end-user computer 16, and a network 18, such as the Internet, LAN or WLAN, which may be wired or wireless. The collaboration application 12 is a software tool that may allow end-users to manage activities such as e-mail, appointments, to-do list items, and notes, for example. The project management application 14 is a software tool that may allow end-users to manage projects, including milestones, deliverables, and tasks.

In one embodiment, the collaboration application 12 is designed support multiple users and may be web-based. The collaboration application 12 may comprise a collaboration client 12a running on the end-user computer 16, that communicates with a collaboration server 12b over the network 18. The collaboration server 12b stores collaboration data from the collaboration client 12a and other collaboration clients (not shown), and serves the data to the collaboration clients. In one embodiment, the collaboration data may include emails, and activities such as appointments, to-do list items, and notes, for example from multiple end-users. The end-user may manually enter activities into the collaboration client 12a, which are then transferred to the collaboration server 12b for storage. The collaboration server 12b may store the collaboration data in a database (not shown).

Similarly, the project management application 14 may be implemented to support multiple users who may modify different sections of a project at once. The project management application 14 may be web-based and comprises a project management client 14a running on the end-user computer 16 that communicates with a project management server 14b. The project management server 14b host project-management data for the project management client 14a and other product clients (not shown) as well as serves the project-management data to the project management clients. In one embodiment, the project-management data may include tasks, including milestones and deliverables. A user may manually enter tasks into the project-management client 14a, which are then transferred to the project-management server 14b for storage. The project management server 14b may store the project-management data in a database (not shown).

According to the exemplary embodiment, the collaboration application 12 has been integrated with the project management application, or otherwise provided with project management functionality, at the user-interface level, so that a user can relate day-to-day activities, such as meetings, to-do list items, and notes, for example, with the tasks in the project management application 14, such as milestones and deliverables. The collaboration client 12a has been modified to make calls 20 to the project management server 14b to communicate activities created in the collaboration client 12a to the project management server 14b and to have those activities integrated with existing project tasks stored by the project management server 14b, as described further below.

Although the exemplary embodiment is shown in an enterprise environment in which the collaboration application 12 and the project-management application 14 are client-server based and run on different computers across a network 18, in an alternative embodiment, one or both of the collaboration or project management applications 12 and 14 may be implemented as a stand-alone application that runs on the end-user computer 16.

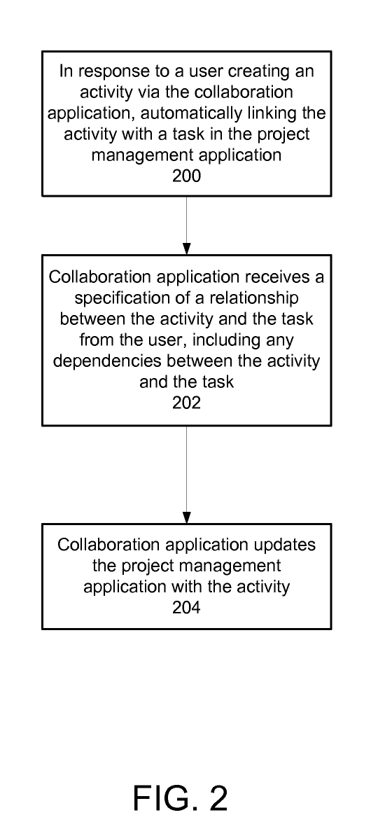

FIG. 2 is a flow diagram illustrating a process for integrating the collaboration application with the project management application in accordance with exemplary embodiment. The process begins in response to a user creating an activity via the collaboration application, the collaboration application automatically links the activity with a task in the project management application (block 200). The collaboration application 12 then receives a specification of a relationship between the activity and the task from the user, including any dependencies between the activity and the task (block 202). The project management application 14 is then updated with the activity (block 204).

The collaboration application 12 in accordance with the exemplary embodiment allows a user to relate an activity created within the collaboration application 12 with a particular task in the project management application 14. For example, the user could make a scheduled meeting a prerequisite for a milestone completion, or could list a “to-do” item on his personal calendar as a sub-task of a formal deliverable in the project management application 14.

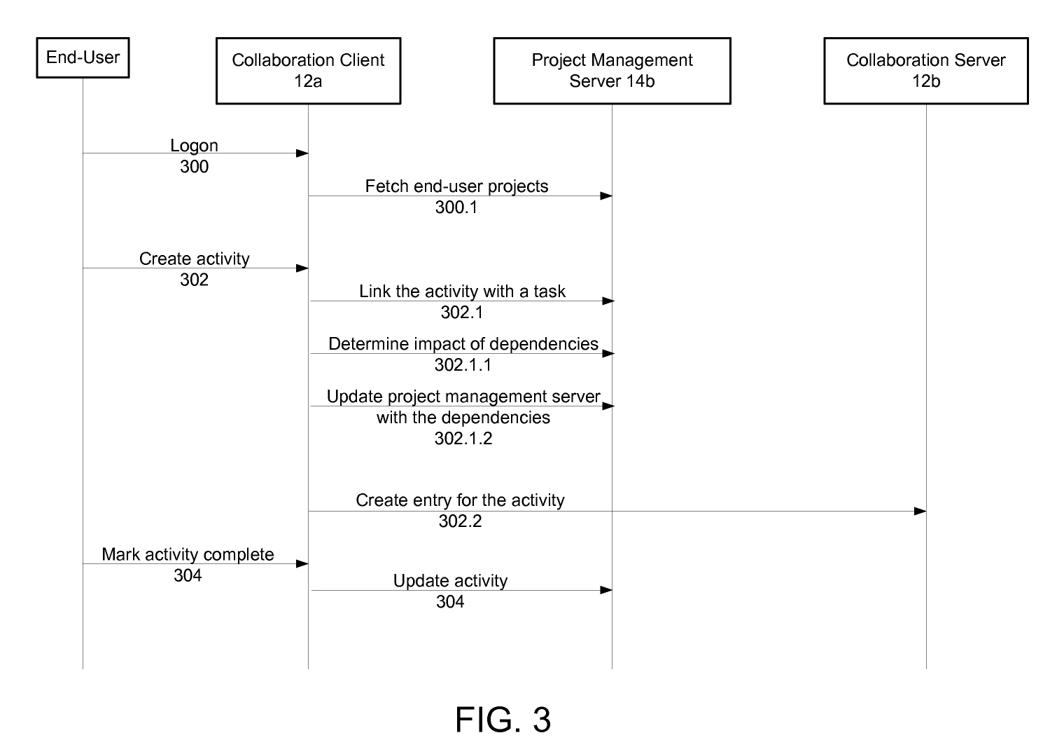

FIG. 3 is a flow diagram illustrating a process for integrating the collaboration application with the project management application in further detail. According to the exemplary embodiment, the collaboration application communicates with, and updates, the project-management application via calls as follows. The process begins when an end-user invokes the collaboration client 12a and logs on (block 300). During startup, the collaboration client 12a communicates with the project management server 14b to fetch a list of all projects associated with the end-user, including information about project tasks, where the project tasks include information about milestones, deliverables, tasks and others (block 300.1). In the exemplary embodiment, the collaboration client 12a communicates with the project management server 14b through a Web service interface of the project management server 14b.

In response to the end-user creating an activity in the collaboration client 12a (block 302), the collaboration client 12a makes a call to the project management server 14b to link the activity with one of the project tasks, where task may include a milestone, deliverable, or task (block 302.1). In one embodiment, the end-user may shown drop down lists of projects and tasks from which to select from. At this point the end-user may also specify a type of dependent relationship between the activity and the task. For example, the activity can be specified as a prerequisite to the project task, such as a “prerequisite for completion” of the project task, or as a “subtask” of the project task. The notion of a prerequisite relationship between the activity and the project task can be extended to the full range of dependent relationships offered by the project management application 14, such as finish-to-start, or finish-to-finish, and the like.

The collaboration client 12a then makes a call to the project management server 14b to determine whether any of the specified dependent relationship(s) breaks any existing commitments (e.g., a prerequisite requisite meeting for a project task making the project task late), and if so, notifies the end-user of the project impact and prompts the end-user whether to proceed (302.1.1).

In response to no conflicts existing or in response to receiving an instruction from the end-user to commit the activity despite existence of conflicts (e.g., because the participants cannot meet sooner), the collaboration client 12a makes a call to the project management server 14b to update the project management server 14b with any of the specified dependent relationship(s) (block 302.1.2).

An entry is also created for the activity in the collaboration server 12b (block 302.2.).

In response to receiving input from the user within the collaboration client 12a that the activity is completed (block 304), the collaboration client 12a makes a call to the project management server 14b to update the project management database that the activity linked to the project task has been completed (block 304.1).

A system of method for integrating a collaboration application with a project management application has been disclosed. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for integrating a collaboration application with a project management application, comprising:
in response to creation of an activity in the collaboration application, linking the activity with a task in the project management application;
receiving a specification of a relationship between the activity and the task, including any dependencies between the activity and the task; and
updating the project management application with the activity.

2. The method of claim 1 wherein updating the project management application further comprises:
determining whether any of the dependencies break any existing commitments, and if so, notifying a user.

3. The method of claim 2 further comprising in response to no conflicts existing or in response receiving an instruction from the user to commit the activity despite existence of conflicts, updating the project management application with the dependencies.

4. The method of claim 1 wherein updating the project management application further comprises:
in response to receiving input from a user within the collaboration application that the activity is completed, updating a project management database of the completion of the activity.

5. The method of claim 1 wherein the collaboration application comprises a collaboration client and a collaboration server, wherein the collaboration client communicates with the collaboration server over a network.

6. The method of claim 1 wherein the project management application comprising a project management client and a project management server, wherein the project management client communicates with the project management server over a network.

7. The method of claim 1 wherein the dependencies between the activity and the task include one of finish-to-start and finish-to-finish.

8. The method of claim 1 wherein the activity comprises at least one of an appointment and an to-do list item.

9. The method of claim 1 wherein the task comprises at least one of a milestone and a deliverable.

10. A system comprising:
a computer;
a collaboration application executing on the computer; and
a project management application executing on the computer;
wherein in response to creation of an activity in the collaboration application, the collaboration application functions to:
link the activity with a task in the project management application;
receive a specification of a relationship between the activity and the task, including any dependencies between the activity and the task; and
update the project management application with the activity.

11. The system of claim 10 wherein the collaboration application makes a call to the project management application to determine whether any of the dependencies break any existing commitments, and if so, notifies a user.

12. The system of claim 11 wherein in response to no conflicts existing or in response receiving an instruction from the user to commit the activity despite existence of conflicts, the collaboration application updates the project management application with the dependencies.

13. The system of claim 10 wherein in response to the collaboration application receiving input from a user that the activity is completed, the collaboration application updates a project management database of the completion of the activity.

14. The system of claim 10 wherein the collaboration application comprises a collaboration client and a collaboration server, wherein the collaboration client communicates with the collaboration server over a network.

15. The system of claim 10 wherein the project management application comprising a project management client and a project management server, wherein the project management client communicates with the project management server over a network.

16. The system of claim 10 wherein the dependencies between the activity and the task include one of finish-to-start and finish-to-finish.

17. The system of claim 10 wherein the activity comprises at least one of an appointment and a to-do list item.

18. The system of claim 10 wherein the task comprises at least one of a milestone and a deliverable.

19. A method for integrating a collaboration application with a project management application, wherein the collaboration application comprises a collaboration client and a collaboration server, and wherein the project management application comprises a project management client and a project management server, the method comprising:
fetching by the collaboration client, a list of all projects associated with an end-user from the project management server, including information about project tasks, wherein the project tasks include milestones, deliverables, tasks;
in response to the end-user creating an activity in the collaboration client, making a first call from the collaboration client to the project management server to link the activity with one of the project tasks;
in response to receiving from the end-user specification of a type of dependent relationship between the activity and the one project task, making a second call from the collaboration client to the project management server to determine whether the dependent relationship breaks any existing commitments, and if so, notifying the end-user and prompting the end-user whether to proceed;
in response to no conflicts existing or in response to receiving an instruction from the end-user to commit the activity despite existence of conflicts, making a third call from the collaboration client to the project management server to update the project management server with the dependent relationship;
creating an entry for the activity in the collaboration server; and
in response to receiving input from the end-user within the collaboration application that the activity is completed, making a fourth call from the collaboration client to the project management server to update a project management database that the activity linked to the one project task has been completed.
